(19) United States
(12) Patent Application Publication
(10) Pub. No.: US 2006/0156930 A1
(43) Pub. Date: Jul. 20, 2006

(54) Fixing mechanism for storage device

(75) Inventor: Wei-Sen Xing, Shenzhen (CN)

Correspondence Address: MORRIS MANNING & MARTIN LLP, 1600 ATLANTA FINANCIAL CENTER, 3343 PEACHTREE ROAD, NE, ATLANTA, GA, 30326-1044, US

(73) Assignee: HON HAI Precision Industry CO., LTD., Tu-Cheng City (TW)

(21) Appl. No.: 11/318,030

(22) Filed: Dec. 23, 2005

(30) Foreign Application Priority Data
Jan. 18, 2005 (CN) 200510032880.1

(51) Int. Cl. A23G 1/10

(52) U.S. Cl. 99/485

(57) ABSTRACT

A fixing mechanism includes a chassis (10) and a bracket (30) detachably attached in the chassis. The chassis includes a top wall (13), a bottom wall (11) and a sidewall (14) connecting the top wall and the bottom wall, and an aperture (131) is defined in the top wall. The bracket includes a first plate (31) for retaining a storage device (50) and a second plate (33) arranged to the first plate. An elastic tab (331) is integrally extended from an end of the second plate, and a protrusion (3311) is formed on the tab engaging in the aperture of the top wall.

### BACKGROUND OF THE INVENTION

1. Field of the Invention

The present invention relates to a fixing mechanism for computer peripheral device, and more particularly to a fixing mechanism for storage device.

2. General Background

U.S. Pat. No. 6,227,632 discloses a fixing mechanism for computer peripheral apparatuses, for example, disc drives. The fixing mechanism includes a plurality of disc drive holders which are respectively inserted into a shell to hold a respective disk drive, each holder including two vertical side rails inserted between lateral side walls of the shell. Two spring plates are respectively raised from the side rails near the top. The spring plates each have a free end terminating in a finger strip, and a retaining portion disposed on the middle for engagement with one retaining hole on one lateral side wall of the shell. However, the spring plate has complicated construction and is uneconomical for rapid mass production. Furthermore, the spring plate has to be mounted to a respective holder to finally assemble the fixing mechanism.

What is desired, therefore, is a fixing mechanism which facilitates rapid mass production.

### SUMMARY

In one preferred embodiment, a fixing mechanism includes a chassis and a bracket detachably attached in the chassis. The chassis includes a top wall, a bottom wall and a sidewall connecting the top wall and the bottom wall, and an aperture is defined in the top wall. The bracket includes a first plate for retaining a device and a second plate arranged to the first plate. An elastic tab is integrally extended from an end of the second plate, and a protrusion is formed on the tab engaging in the aperture of the top wall.

Other advantages and novel features will become more apparent from the following detailed description of the preferred embodiment when taken in conjunction with the accompanying drawing, in which:

### BRIEF DESCRIPTION OF THE DRAWING

FIG. 1 is an exploded, isometric view of a fixing mechanism in accordance with a preferred embodiment of the present invention together with a storage device.

### DETAILED DESCRIPTION OF THE EMBODIMENT

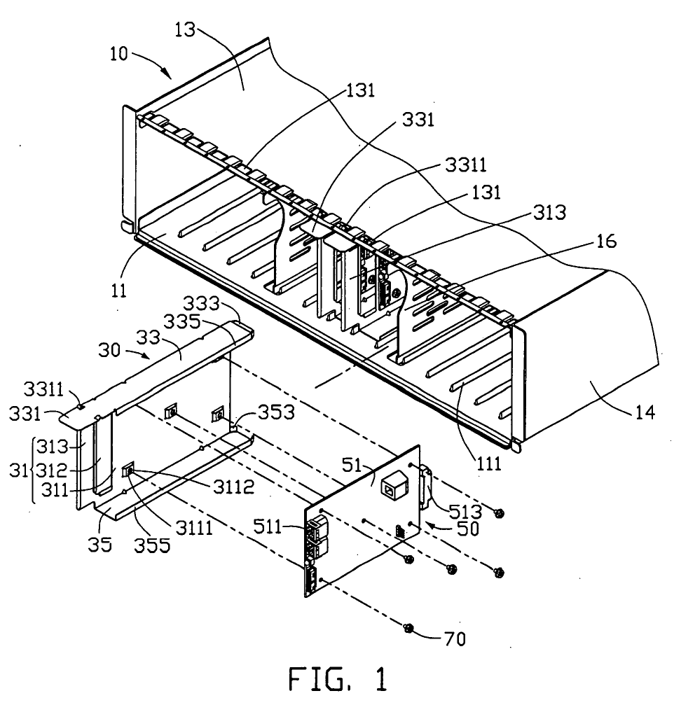

Referring to FIG. 1, a fixing mechanism is provided to fix a plurality of storage devices 50 into an electronic apparatus, the fixing mechanism including a chassis 10 of the electronic apparatus and a plurality of brackets 30 corresponding to the storage devices 50.

The chassis 10 includes a bottom wall 11, a top wall 13 and two parallel sidewalls 14 connecting the bottom wall 11 and the top wall 13. A pair of reinforcing walls 16 is formed between the sidewalls 14. A plurality of ribs 111 is formed on the bottom and top walls 11, 13 respectively, for guiding sliding of the brackets 30. An aperture 131 is defined in the top wall 13 at front of each rib 111.

Each bracket 30 includes a rectangle first plate 31. A second plate 33 and a third plate 34 are extended in parallel from upper and lower edges of the first plate 31 respectively. A vertical opening 312 is defined in a front portion of the first plate 31 thereby dividing the first plate 31 into a knob portion 313 and a supporting portion 311. A plurality of retaining seats 3111 protrudes from the supporting portion 311, for retaining a respective storage device 50. A threaded hole 3112 is defined in each retaining seat 3111. An elastic cantilevered tab 331 integrally protrudes forward from a front end of the second plate 33. A pair of arcuate protrusions 3311 is formed on opposite side edges of the tab 331, corresponding to a respective aperture 131 of the top wall 13 of the chassis 10. A sloped guide portion 333 is bent from a rear end of the second plate 33, for facilitating entering the chassis 10. A flange 335 is bent downwardly from a free edge of the second plate 33. A sloped guide portion 353 is bent from a rear end of the third plate 35, for facilitating entering the chassis 10. A flange 355 is bent upwardly from a free edge of the third plate 35.

Each storage device 50 includes a circuit board 51 and a plurality of function components mounted on the circuit board 51. A pair of first connectors 511 is electrically connected to a front end of the circuit board 51. A second connector 513 is electrically connected to a rear end of the circuit board 51.

In use, taking one storage device 50 as an example, the storage device 50 is aligned with the retaining seats 3111 of the first plate 311 of one bracket 30. A plurality of screws 70 is extended through the circuit board 51 of the storage device 50 and engaged in the retaining holes 3112 respectively of the first plate 311 to attach the storage device 50 to the bracket 30. The combined bracket 30 and storage device 50 is slid into the chassis 10 along respective ribs 111 thereof. During the movement of the combined bracket 30 and storage device 50, the flanges 335, 355 and the first plate 31 of the bracket 30 are engaged with the respective ribs 111. The tab 331 of the second plate 33 is urged downwardly when the protrusions 3311 of the tab 331 engages with the top wall 13 of the chassis 10, and the tab 331 is finally restored to drive the protrusions 3311 into respective apertures 131 of the top wall 13. The combined bracket 30 and storage device 50 is thus fixed in the chassis 10. FIG. 1 shows two storage devices 50 are attached in the chassis 10, and two neighboring protrusions 3311 of two brackets 30 engage in one aperture 131 of the chassis 10.

To detach the storage device 50, the tab 331 of the second plate 33 of the bracket 30 is pressed downwardly to disengage the protrusions 3311 from the respective apertures 131. The combined bracket 30 and storage device 50 can be pulled out from the chassis 10 and then moved to a desired place for serving the storage device 50 by gripping the knob portion 313.

It is believed that the present embodiment and its advantages will be understood from the foregoing description, and it will be apparent that various changes may be made thereto without departing from the spirit and scope of the invention or sacrificing all of its material advantages, the example hereinbefore described merely being one preferred or exemplary embodiment.

What is claimed is:

1. A fixing mechanism comprising:
a chassis comprising a top wall, a bottom wall and a sidewall connecting the top wall and the bottom wall, an aperture being defined in the top wall; and
a bracket detachably attached in the chassis, the bracket comprising a first plate for retaining a device and a second plate arranged to the first plate, an elastic tab integrally extending from an end of the second plate, a protrusion being formed on the tab engaging in the aperture of the top wall.

2. The fixing mechanism as claimed in claim 1, wherein an opening is defined in the first plate of the bracket to divide the first plate into a knob portion for facilitating taking the bracket and a supporting portion for retaining the device thereon.

3. The fixing mechanism as claimed in claim 2, wherein a plurality of retaining seats is arranged on the supporting portion, and a plurality of screws is provided for attaching the device to the retaining seats.

4. The fixing mechanism as claimed in claim 1, wherein a plurality of ribs is arranged to the top and bottom walls respectively sandwiching and guiding the bracket sliding in the chassis.

5. The fixing mechanism as claimed in claim 4, wherein a flange is arranged to the second plate of the bracket engaging with a respective rib of the top wall.

6. The fixing mechanism as claimed in claim 4, wherein a sloped guide portion is formed at the second plate of the bracket facilitating entering the chassis.

7. The fixing mechanism as claimed in claim 1, wherein a third plate is arranged to the first plate of the bracket in parallel with the second plate.

8. A fixing mechanism comprising:
a chassis comprising a top wall, a bottom wall and a sidewall connecting the top wall and the bottom wall, an aperture being defined in the top wall; and
first and second brackets detachably attached in the chassis for holding two devices respectively, each of the first and second brackets comprising a first plate having an elastic tab integrally extending from an end thereof, a protrusion being formed on the tab engaging in the aperture of the top wall.

9. The fixing mechanism as claimed in claim 8, wherein the protrusion of the first bracket is formed on a side edge of the tab, and the protrusion of the second bracket is formed on a side edge of the tab thereof neighboring the side edge of the tab of the first bracket.

10. The fixing mechanism as claimed in claim 9, wherein the tab of each of the first and second brackets forms another protrusion on another side edge thereof, correspondingly two more apertures are defined in the top wall of the chassis.

11. The fixing mechanism as claimed in claim 8, wherein each of the first and second brackets further comprises a second plate for retaining a respective device and a third plate in parallel with the first plate.

12. The fixing mechanism as claimed in claim 11, wherein an opening is defined in the second plate of each of the first and second brackets to divide the first plate into a knob portion for facilitating taking respective bracket and a supporting portion for retaining the respective device thereon.

13. The fixing mechanism as claimed in claim 8, wherein a plurality of ribs is arranged to the top and bottom walls respectively sandwiching and guiding the first and second brackets sliding in the chassis.

14. An electronic apparatus comprising:
a chassis of said electronic apparatus defining a receiving space therein;
a device for function extension of said electronic apparatus; and
a bracket corresponding to said device for receiving said device therein, said bracket movably installable in said receiving space together with said received device and engagable with said chassis so as to secure said bracket and said received device to said chassis in said receiving space, a tab extending from said bracket exposable out of said space so as to be operable to disable engagement between said bracket and said chassis for releasing said bracket and said received device.

15. The electronic apparatus as claimed in claim 14, wherein at least two protrusions are formed on said bracket to perform said engagement of said bracket with said chassis and are movably operable together with said tab, each of said at least two protrusions is engagable with a correspondingly respective aperture aligned with other apertures for said engagement.
